(19) United States
(12) Patent Application Publication
(10) Pub. No.: US 2018/0361269 A1
(43) Pub. Date: Dec. 20, 2018

(54) ENERGY EFFICIENT DISTILLING HEAT PUMP AND VARIANTS THEREOF

(71) Applicants: Serguei A. Popov, Houston, TX (US); Elizabeth S. Popov, Houston, TX (US)

(72) Inventors: Serguei A. Popov, Houston, TX (US); Elizabeth S. Popov, Houston, TX (US)

(21) Appl. No.: 15/841,365

(22) Filed: Dec. 14, 2017

Related U.S. Application Data
(62) Division of application No. 14/840,096, filed on Aug. 31, 2015, now abandoned.

(51) Int. Cl. B01D 3/00; B01D 3/10

(52) U.S. Cl. CPC B01D 3/007; B01D 3/101; Y02B 30/52; B01D 3/105

(57) ABSTRACT

A method for distilling a fluid includes moving a fluid to be distilled into a distilling column. A motive fluid is pumped into a liquid-driven gas ejector. Gas from a vapor outlet of the distilling column is discharged into a gas inlet of the ejector. Fluid is conducted from an outlet of the ejector into a heat exchanger. Heat from fluid conducted from the ejector is transferred to at least one of the fluid moved into the distilling column and an interior of the distilling column.

### CROSS REFERENCE TO RELATED APPLICATIONS

Divisional of U.S. application Ser. No. 14/840,096 filed Aug. 31, 2015 and incorporated herein by reference in its entirety.

### STATEMENT REGARDING FEDERALLY SPONSORED RESEARCH OF DEVELOPMENT

Not Applicable.

### NAMES TO THE PARTIES TO A JOINT RESEARCH AGREEMENT

Not Applicable.

### BACKGROUND

This disclosure is related to the field of separation technology, primarily but not exclusively separators used in power generation, food processing, oil refining, petrochemical production, gas processing and other industrial applications.

A process known in the art for recovering components from a mixture having lower boiling points than other components in the mixture uses a distilling column, a compressor, a cooler, a condenser, a heater and a final separator. The heater is connected by a vapor product line to the compressor, and by a two-phase product line to the condenser. The condenser is connected at its outlet to the final separator, wherein the compressor is connected by a vapor with the heater. The heater is connected by a vapor line with the cooler. The heater is connected by a liquid with the bottom of the distilling column. A vapor phase outlet from the distilling column is connected to the cooler to be heated and then conducted to the compressor for compression, wherein a compressed vapor from the compressor is conducted to a heater for heating a liquid in the bottom of the distilling column. Partially cooled and condensed compressed vapor is conducted to a cooler for cooling and partial condensation, wherein a cooled and partially condensed two-phase mixture is conducted to a condenser for final cooling and condensation. A two-phase mixture from the outlet of the condenser is fed to a final separator. See, for example, U.S. Pat. No. 9,045,697 issued Jun. 2, 2015 to Sadler et al. Operation of such a process has relatively low energy efficiency.

### BRIEF DESCRIPTION OF THE DRAWINGS

FIG. 1 shows a schematic diagram of an example embodiment of a distilling heat pump unit

FIG. 2 shows a schematic diagram of an example embodiment of a distilling heat pump unit without the separator shown in FIG. 1 and with a cooler, made as a standalone cooler.

FIG. 3 shows a schematic diagram of an example embodiment of a condensing and absorbing gas compression unit, which includes a distilling column vapor product draw off to an outside source.

FIG. 4 shows a schematic diagram of another example embodiment of a distilling heat pump unit, which includes a heater.

FIG. 5 shows a schematic diagram of example embodiment of a distilling heat pump unit with a cooler that heats a distilling column raw feed.

### DETAILED DESCRIPTION

The present disclosure relates to a distilling heat pump having increased energy efficiency and operational reliability. Increased efficiency may be provided by combining gas compression and condensation in a liquid-driven gas ejector using fluids of the same or similar composition as a lower boiling-point product, and separating low molecular weight components from a multiple component liquid, with an extended control range of its operational characteristics.

A distilling heat pump according to the present disclosure may include a liquid-driven gas ejector, a heat exchanger, a distilling column and a pump. A liquid outlet from the pump is connected to the liquid inlet of the liquid-driven gas ejector. The suction port of the liquid-driven gas ejector is connected to a vapor outlet port of the distilling column. The outlet port of the liquid-driven gas ejector is connected to the inlet of the heat exchanger. The outlet of the heat exchanger may be coupled to the inlet port of the pump so as to form a motive fluid circulation loop. In this way, vapor product of the distilling column may be compressed and condensed. The heat of condensation may be transferred through various embodiments of the heat exchanger to the distilling column and/or to the raw feed fluid entering the distilling column. Thus, less heat may be needed to perform distillation of raw feed fluid.

In some embodiments, the outlet of the heat exchanger is connected to the inlet of a separator, the liquid outlet of which is connected to a fluid takeoff connection or “tee”, of which one outlet is connected to the liquid inlet of a pump. The other outlet of the tee may be used to withdraw liquid from the fluid circulation loop for use by external consumers.

In some embodiments, the heat exchanger may be located inside the bottom of the distilling column to heat and boil liquid in the distilling column bottom to perform a separation of higher boiling temperature products from lower boiling temperature products by transferring heat of condensation immediately upstream of a separator.

To perform a heat transfer to cool the circulating motive fluid and to heat the raw feed in the distilling column, the circulating motive fluid is maintained at a temperature above the temperature at the bottom of the distilling column in a range from 0.5° F. to 450° F. Such temperature difference may be obtained by condensing or partially condensing the distilling column vapor in the liquid-driven gas ejector, wherein heat of condensation is absorbed by the circulating motive fluid. The heat of condensation is transferred in the heat exchanger to the medium being distilled in the distilling column. A range of temperature differences between the circulating motive fluid and the medium was experimentally simulated. A lower limit of this range (0.5° F.) represents the minimum temperature differential to maintain sufficient driving force to conduct the heat transfer in a heat exchanger, and an upper limit (450° F.) is the maximum temperature differential considered to be practical. The temperature differential may be controlled by the balance between the heat including the latent heat absorbed in a liquid driven gas ejector and the heat transferred to the bottom of the distilling column. For example, the temperature range may be controlled by opening or closing a bypass valve around the heat exchanger.

In some embodiments, the pressure at the top of the distilling column may be controlled by operating the liquid-driven gas ejector at a selected flow rate. This also increases efficiency of extraction of heavy components from the raw feed.

In some embodiments, a tee may be located downstream of a liquid outlet of a separator to draw off some of the circulated liquid as a product. In some embodiments, gas may be drawn from a gas outlet of the separator as a product.

In some embodiments, a heat exchanger may be located between a liquid-driven gas ejector and a separator, wherein the heat exchanger transfers the from the circulating liquid to the medium input to a distilling column. The temperature differential between the distilling column input fluid temperature and the circulated motive fluid temperature is maintained in a range from 0.2° F. to 520° F.

Several example embodiments of the distilling heat pump according to the present disclosure will be described in more detail with reference to the Figures.

Experiments have demonstrated that a condensing, liquid-driven gas ejector connected at its liquid inlet port to the outlet of a circulating pump, and at its outlet port to a distilling column through a heat exchanger, and whose gas inlet port is connected to the distilling column vapor outlet port provides gas compression, condensation and absorption of high molecular weight components from the original distilling column overhead mixture. Near isothermal compression, partial or full condensation of the compressed gas, and partial absorption of the heat of condensation by recirculating liquid enables transfer of the heat released by condensation to the fluid entering or already inside the distilling column. Such heat transfer may substantially reduce the heat required to perform distillation of an input fluid stream and to operate the distilling column.

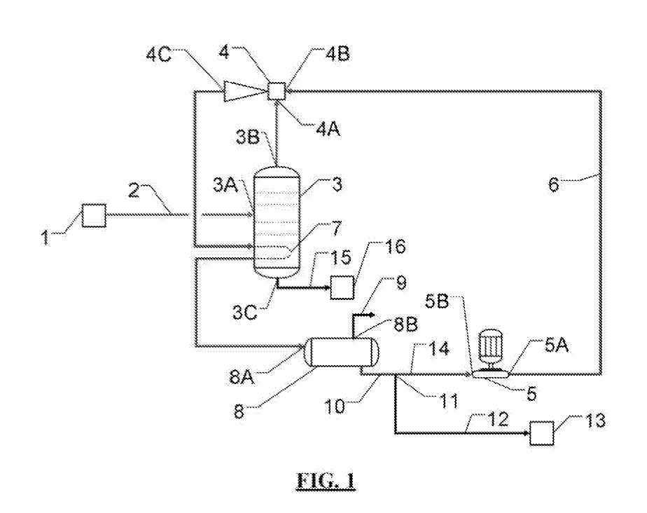

FIG. 1 is a schematic diagram of an example embodiment of a distilling heat pump. Raw, i.e., undistilled, multiple component fluid from an outside source (1) may be conducted to a fluid inlet port (3A) of a distilling column (3) through an inlet conduit (2). A vapor outlet port (3B) of the distilling column (3) is connected to a gas inlet port (4A) of a liquid-driven gas ejector (4). A liquid inlet port (4B) of the liquid-driven gas ejector (4) is connected to the outlet (5A) of a pump (5) to supply a circulating liquid motive fluid in a motive fluid circulation loop (6) to the liquid-driven gas ejector (4). A discharge port (4C) of the liquid-driven gas ejector (4) is connected, through a heat exchanger (7), with the inlet port (8A) of a separator (8). In the present embodiment, the heat exchanger (7) may be disposed inside the distilling column (3). The separator (8) may be used in some embodiments to extract gases from a motive fluid circulation loop which includes the pump (5), the liquid driven gas ejector (4) and the heat exchanger (7).

Gaseous output product (9) from a vapor port (8B) in the separator (8) may directed to outside consumers. A liquid product output from a liquid output port (10) of the separator (8) may be conducted to a “tee” connection (11), wherein a first part (12) of the liquid product (10) is withdrawn from the motive fluid circulation loop of the distilling heat pump, and sent to external consumers (13). The remainder (14) of the liquid product (10) is directed to the inlet port (5B) of the pump (5) for circulation through the motive fluid circulation loop. Liquid product (15) may be withdrawn from the distilling column (3) through a distilling column liquid outlet port (3C) and sent to external consumers (16). In the embodiment of FIG. 1, some of the heat of condensation released by compression and condensation of gas in the liquid-driven gas ejector (4) is transferred to the distilling column (3) by the heat exchanger (7), thereby reducing the amount of heat needed to operate the distilling column.

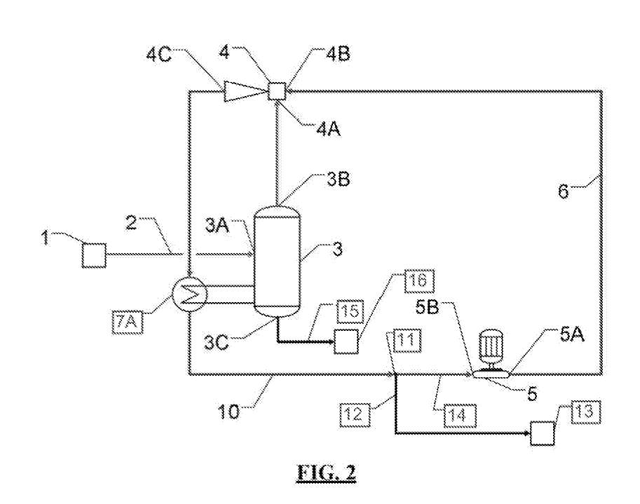

FIG. 2 shows a schematic diagram of an example embodiment of a distilling heat pump unit without the separator shown in FIG. 1 and with a heat exchanger made as a standalone device separate from the distilling column. Raw feed fluid from the outside source (1) is conducted by the inlet conduit (3) to the inlet port (3A) of the distilling column (3) as in the example embodiment of FIG. 1. The vapor outlet port (3B) of the distilling column (3) is connected to the gas inlet port (4A) of the liquid-driven gas ejector (4) as in the previous example embodiment. The liquid-driven gas ejector (4) liquid inlet port (4B) is connected to the pump (5) outlet port (5A) to supply motive fluid through the motive fluid circulation loop (6) to the liquid-driven gas ejector (4). The liquid-driven gas ejector discharge port (4C) is connected through a heat exchanger (7A) with the fluid take off connection or “tee” (11), wherein a first part (12) of the liquid (10) is withdrawn from the motive fluid circulation loop (6) and sent to external consumers (11), and the remainder (14) is directed to the pump (5) inlet port (5B). Liquid product (15) is withdrawn from the liquid outlet port (3C) of the distilling column (3) and may be sent to external consumers (16).

In the embodiment of FIG. 2, heat from the circulating motive fluid may be transferred to the fluid inside the distilling column (3) by the heat exchanger (7A) so as to reduce the amount of heat needed to operate the distilling column (3).

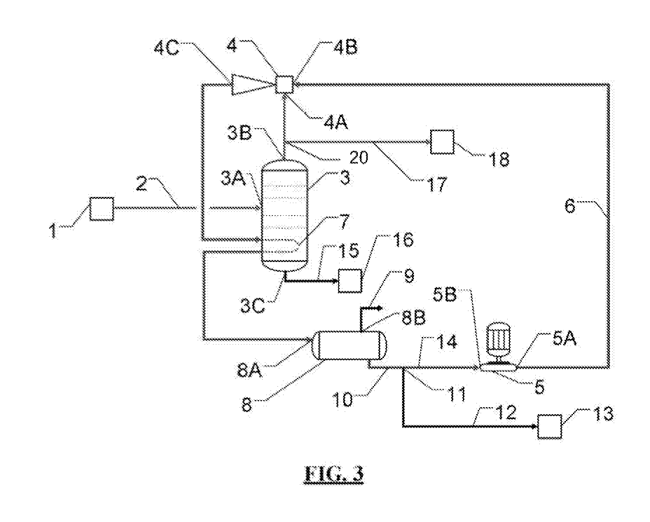

FIG. 3 shows a schematic diagram of an example embodiment of a condensing and absorbing gas compression unit, which includes a distilling column vapor product draw off to an outside source.

Raw, i.e., undistilled, multiple component fluid from an outside source (1) may be conducted to a fluid inlet port (3A) of a distilling column (3) through an inlet conduit (2). A vapor outlet port (3B) of the distilling column (3) is connected to a gas inlet port (4A) of a liquid-driven gas ejector (4). A liquid inlet port (4B) of the liquid-driven gas ejector (4) is connected to the outlet (5A) of a pump (5) to supply a circulating liquid motive fluid in a motive fluid circulation loop (6) to the liquid-driven gas ejector (4). A discharge port (4C) of the liquid-driven gas ejector (4) is connected, through a heat exchanger (7), with the inlet port (8A) of a separator (8). In the present embodiment, the heat exchanger (7) may be disposed inside the distilling column (3). The separator (8) may be used in some embodiments to extract gases from a motive fluid circulation loop which includes the pump (5), the liquid driven gas ejector (4) and the heat exchanger (7).

Gaseous output product (9) from a vapor port (8B) in the separator (8) may directed to outside consumers. A liquid product output from a liquid output port (10) of the separator (8) may be conducted to a “tee” connection (11), wherein a first part (12) of the liquid product (10) is withdrawn from the motive fluid circulation loop of the distilling heat pump, and sent to external consumers (13). The remainder (14) of the liquid product (10) is directed to the inlet port (5B) of the pump (5) for circulation through the motive fluid circulation loop. Liquid product (15) may be withdrawn from the distilling column (3) through a distilling column liquid outlet port (3C) and sent to external consumers (16). In the embodiment of FIG. 1, some of the heat of condensation released by compression and condensation of gas in the liquid-driven gas ejector (4) is transferred to the distilling column (3) by the heat exchanger (7), thereby reducing the amount of heat needed to operate the distilling column.

In the example embodiment of FIG. 3, the vapor outlet port (3B) connection to the liquid-driven gas ejector (4) may include a second “tee” connection (20), wherein part of the distilling column vapor product (17) is drawn therefrom and may be sent to external consumers (18).

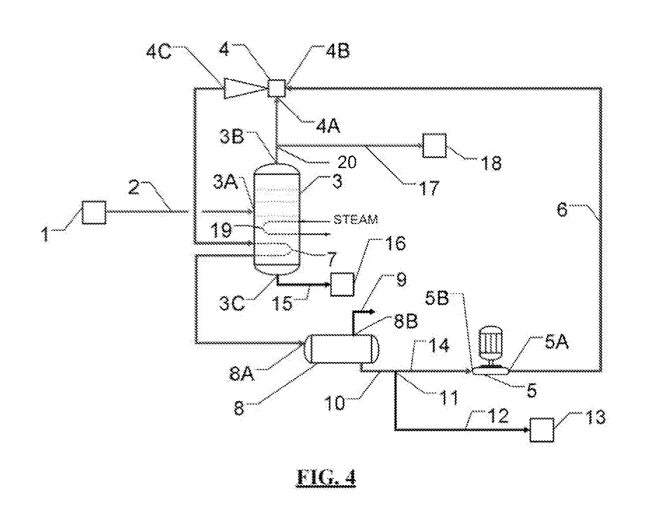

FIG. 4 shows a schematic diagram of another example embodiment of a distilling heat pump unit, which includes a heater.

Raw, i.e., undistilled, multiple component fluid from an outside source (1) may be conducted to a fluid inlet port (3A) of a distilling column (3) through an inlet conduit (2). A vapor outlet port (3B) of the distilling column (3) is connected to a gas inlet port (4A) of a liquid-driven gas ejector (4). A liquid inlet port (4B) of the liquid-driven gas ejector (4) is connected to the outlet (5A) of a pump (5) to supply a circulating liquid motive fluid in a motive fluid circulation loop (6) to the liquid-driven gas ejector (4). A discharge port (4C) of the liquid-driven gas ejector (4) is connected, through a heat exchanger (7), with the inlet port (8A) of a separator (8). In the present embodiment, the heat exchanger (7) may be disposed inside the distilling column (3). The separator (8) may be used in some embodiments to extract gases from a motive fluid circulation loop which includes the pump (5), the liquid driven gas ejector (4) and the heat exchanger (7).

Gaseous output product (9) from a vapor port (8B) in the separator (8) may directed to outside consumers. A liquid product output from a liquid output port (10) of the separator (8) may be conducted to a “tee” connection (11), wherein a first part (12) of the liquid product (10) is withdrawn from the motive fluid circulation loop of the distilling heat pump, and sent to external consumers (13). The remainder (14) of the liquid product (10) is directed to the inlet port (5B) of the pump (5) for circulation through the motive fluid circulation loop. Liquid product (15) may be withdrawn from the distilling column (3) through a distilling column liquid outlet port (3C) and sent to external consumers (16). In the embodiment of FIG. 1, some of the heat of condensation released by compression and condensation of gas in the liquid-driven gas ejector (4) is transferred to the distilling column (3) by the heat exchanger (7), thereby reducing the amount of heat needed to operate the distilling column.

In the example embodiment of FIG. 3, the vapor outlet port (3B) connection to the liquid-driven gas ejector (4) may include a second “tee” connection (20), wherein part of the distilling column vapor product (17) is drawn therefrom and may be sent to external consumers (18). In the example embodiment of FIG. 4, the distilling column (3) has a heater (19) to heat fluid in the bottom of the distilling column (3) to facilitate distillation of the fluid therein. The heater (19) may be, for example a steam driven heat exchanger.

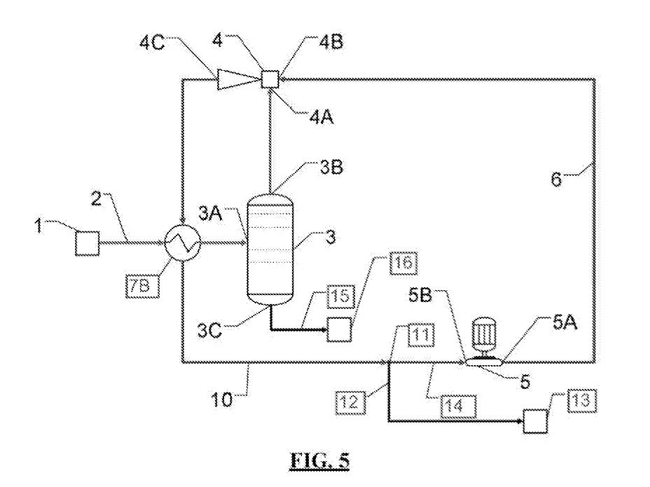

FIG. 5 shows a schematic diagram of example embodiment of a distilling heat pump unit with a heat exchanger that heats the distilling column raw feed.

FIG. 5 shows a schematic diagram of an example embodiment of a distilling heat pump as in FIG. 2 but with a heat exchanger used to head the raw feed to the distilling column prior to movement of the raw feed into the distilling column. Raw feed fluid from the outside source (1) is conducted by the inlet conduit (3) to the inlet port (3A) of the distilling column (3) as in the example embodiment of FIG. 2. The vapor outlet port (3B) of the distilling column (3) is connected to the gas inlet port (4A) of the liquid-driven gas ejector (4) as in the previous example embodiment. The liquid-driven gas ejector (4) liquid inlet port (4B) is connected to the pump (5) outlet port (5A) to supply motive fluid through the motive fluid circulation loop (6) to the liquid-driven gas ejector (4). The liquid-driven gas ejector discharge port (4C) is connected through a heat exchanger (7B) with the tee (11), wherein a first part (12) of the liquid (10) may be withdrawn from the motive fluid circulation loop (6) and sent to external consumers (11), and the remainder (14) is directed to the pump (5) inlet port (5B). Liquid product (15) is withdrawn from the liquid outlet port (3C) of the distilling column (3) and may be sent to external consumers (16). In the present embodiment heat of condensation of gas released into the motive fluid may be transferred to the raw feed by the heat exchanger (7B), thus increasing its temperature prior to entry into the distilling column (3).

In any of the example embodiments described with reference to FIGS. 1 through 5, the flow rate of motive liquid through the liquid-driven gas ejector, the dimensions of the liquid-driven gas ejector and the flow rate of gas from the distilling column into the liquid-driven just ejector may be selected such that the gas that is input to the ejector is fully condensed and only liquid is discharged from the outlet of the ejector. The flow rate of fluid through the ejector may be controlled by operating the pump to provide the selected flow rate.

In some embodiments, the motive fluid temperature at the ejector liquid inlet is maintained in a range from 0.2° F. to 520° F. higher than the temperature of the distilling column raw feed inlet.

In some embodiments, the ejector motive fluid inlet temperature is maintained in a range from 0.5° F. to 450° F. higher than the ejector vapor inlet temperature.

In some embodiments, the pump is operated such that the ejector motive fluid weight flow rate is from 2.2 to 560 times the weight flow rate of the gas input to the ejector.

In some embodiments, the motive fluid has a boiling point temperature range with an uppermost boiling point of not more than 200° F. above the uppermost boiling point of condensed gas discharged from the ejector.

In some embodiments, the pump is operated such that the ejector motive fluid inlet pressure is in a range of 1.4 to 660 times the ejector discharge pressure. This pressure ratio range has been established through simulation as sufficient for the liquid driven gas ejector to perform, and to be practical. The pressure ratio between the liquid-driven gas ejector outlet and the motive fluid inlet is set by the liquid-driven gas ejector design.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for distilling a fluid, comprising:
moving a fluid to be distilled into a distilling column;
pumping a motive fluid into a liquid-driven gas ejector;
discharging gas from a vapor outlet of the distilling column into a gas inlet of the ejector;
conducting fluid from an outlet of the ejector into a heat exchanger; and
transferring heat from fluid conducted from the ejector to at least one of the fluid moved into the distilling column and an interior of the distilling column.

2. The method of claim 1 further comprising conducting at least part of fluid discharged from the heat exchanger to an external consumer.

3. The method of claim 1 further comprising conducting fluid discharged from the heat exchanger to a separator.

4. The method of claim 3 further comprising conducting gas discharged to the separator to an external consumer.

5. The method of claim 1 wherein the motive fluid temperature at the inlet to the ejector is maintained in a range from 0.2° F. to 520° F. higher than the temperature of the fluid moved into the distilling column.

6. The method of claim 1 wherein the motive fluid temperature at the inlet to the ejector is maintained in a range from 0.5° F. to 450° F. higher than the ejector gas inlet temperature.

7. The method of claim 1 wherein the motive fluid weight flow rate is in a range from 2.2 to 560 times a weight flow rate of gas input to the ejector.

8. The method of claim 1 wherein the motive fluid has a boiling point temperature range with an uppermost boiling point of not more than 200° F. above the uppermost boiling point of condensed gas discharged from the ejector.

9. The method of claim 1 wherein an ejector motive fluid inlet pressure is in a range of 1.4 to 660 times an ejector discharge pressure.

10. The method of claim 1 further comprising conducting part of the gas discharged from the distilling column to an external consumer.
